(19) United States
(12) Patent Application Publication
(10) Pub. No.: US 2024/0286949 A1
(43) Pub. Date: Aug. 29, 2024

(54) ENAMEL COMPOSITION, METHOD FOR PREPARING ENAMEL COMPOSITION, AND COOKING APPLIANCE

(71) Applicant: LG ELECTRONICS INC., Seoul (KR)

(72) Inventors: Suyeon CHOI, Seoul (KR); Young Seok KIM, Seoul (KR)

(21) Appl. No.: 18/651,451

(22) Filed: Apr. 30, 2024

Related U.S. Application Data
(62) Division of application No. 16/795,959, filed on Feb. 20, 2020, now Pat. No. 12,006,257.

(30) Foreign Application Priority Data
Feb. 22, 2019 (KR) 10-2019-0021145

(51) Int. Cl. C03C 8/06; C03C 3/066; C03C 3/068; C03C 3/115; C03C 17/04; C23D 5/02; C23D 5/04; F24C 15/00; F24C 15/02

(52) U.S. Cl. CPC C03C 8/06; C03C 3/066; C03C 3/068; C03C 3/115; C03C 17/04; F24C 15/005; F24C 15/02; C03C 2207/04; C03C 2218/17; C23D 5/02; C23D 5/04

(57) ABSTRACT

An enamel composition, a method for preparing an enamel composition, and a cooking appliance are provided. The enamel composition may include 15 to 50 wt % of silicon dioxide (SiO₂); 1 to 10 wt % of boron oxide (B₂O₃); 10 to 20 wt % of at least one of lithium oxide (Li₂O), sodium oxide (Na₂O), or potassium oxide (K₂O); 1 to 5 wt % of sodium fluoride (NaF); 1 to 10 wt % of zinc oxide (ZnO); and 20 to 50 wt % of at least one of titanium dioxide (TiO₂), molybdenum oxide (MoO₃), bismuth oxide (Bi₂O₃), cerium dioxide (CeO₂), manganese dioxide (MnO₂), or Iron oxide (Fe₂O₃), which provides an enamel composition with a reduced cleaning time, and facilitates cleaning without soaking in water.

### CROSS-REFERENCE TO RELATED APPLICATION(S)

This application is a Division of U.S. patent application Ser. No. 16/795,959, filed Feb. 20, 2020, which claims priority to and the benefit of Korean Patent Application No. 10-2019-0021145, filed in Korea on Feb. 22, 2019, the disclosure of which is incorporated herein by reference in its entirety.

### BACKGROUND

### 1. Field

An enamel composition, a method for preparing an enamel composition, and a cooking appliance are disclosed herein.

### 2. Background

Enamels may be prepared by applying a glass glaze to a surface of a metal plate. Enamels may be used in cooking appliances, such as microwaves and ovens. Cooking appliances, such as microwaves and gas ovens, may cook food or other items (hereinafter, collectively “food”) using a heating source. As contaminants generated during the cooking may be adhered to an inner wall of a cavity of the cooking appliance, the inner wall of the cavity thereof may be cleaned. The enamel may be coated on a surface of the inner wall of the cavity of the cooking appliances to facilitate removal of contaminants from the cooking appliances. For example, pyrolysis methods for burning contaminants at high temperatures to ashes may be used to easily clean the inner wall of the cavity. The enamel composition including components, such as phosphorus pentoxide (P₂O₅), silicon dioxide (SiO₂), and boron oxide (B₂O₃) may be used with pyrolysis methods.

Other enamel compositions may have greater energy consumption because cleaning may be performed by heating for about four hours under high temperature conditions, for example, a temperature range of 450 to 500° C. for pyrolysis. Other enamel compositions may require a soaking process in water for a certain period of time in order to remove oil contaminants, such as beef, pork, and poultry, thereby resulting in a complicated cleaning processes. The enamel composition may not be deformed and damaged at a high temperature range of 450 to 500° C.; however, other enamel compositions have degraded durability at high temperatures.

### BRIEF DESCRIPTION OF THE DRAWINGS

Embodiments will be described in detail with reference to the following drawings in which like reference numerals refer to like elements, and wherein:

FIG. 1 is a front perspective view of a cooking appliance according to an embodiment;

FIG. 2 is a partial enlarged cross-sectional view of a portion of an inner surface of a cavity of the cooking appliance in FIG. 1;

FIG. 3 is a partial enlarged cross-sectional view of a portion of an inner surface of a door of the cooking appliance in FIG. 1;

FIG. 4 is a flow chart of a method for preparing an enamel composition according to an embodiment.

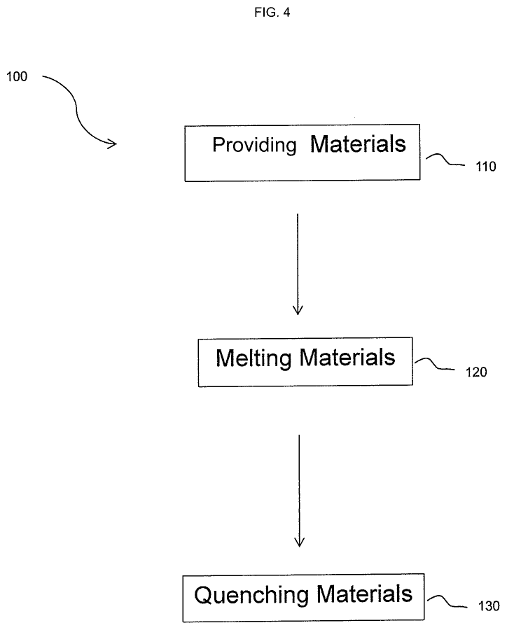

### DETAILED DESCRIPTION

### Enamel Composition

An enamel composition, according to embodiments, may include 15 to 50 wt % of silicon dioxide (SiO₂); 1 to 10 wt % of boron oxide (B₂O₃); 10 to 20 wt % of at least one of lithium oxide (Li₂O), sodium oxide (Na₂O), or potassium oxide (K₂O); 1 to 5 wt % of sodium fluoride (NaF); 1 to 10 wt % of zinc oxide (ZnO); and 20 to 50 wt % of at least one of titanium dioxide (TiO₂), molybdenum oxide (MoO₃), bismuth oxide (Bi₂O₃), cerium dioxide (CeO₂), manganese dioxide (MnO₂), or Iron oxide (Fe₂O₃).

SiO₂ forms a glass structure and may be used to improve chemical resistance of the enamel composition by strengthening a skeleton of the glass structure and to facilitate achievement of properties of metal oxide which functions as a catalyst. As the catalytic metal oxide is inferior in heat resistance or chemical resistance to other components, a large amount of catalytic metal oxide may not be included in the enamel composition. However, SiO₂ may be used in an appropriate amount in the glass to improve solubility of the catalytic metal oxide due to a greater pore size of SiO₂. Accordingly, the heat resistance and the chemical resistance thereof may be improved and properties of the catalytic metal oxide may be achieved by properly adjusting a content ratio of each of SiO₂ and the catalytic metal oxide. SiO₂ may be contained in the enamel composition in a range of 15 to 50 wt %. If the content of SiO₂ exceeds 50 wt %, the addition of other components may be prevented, thereby degrading a cleaning performance. If the content of SiO₂ is less than 15 wt %, silicate-based glass composition according to embodiments may be disrupted.

B₂O₃ functions as a glass-forming agent and may function to uniformly dissolve the components of the enamel composition. B₂O₃ may improve a coating performance of the enamel composition by controlling a coefficient of thermal expansion and fusion flow of the enamel composition. B₂O₃ may maintain an appropriate viscosity during an enamel firing process and control the glass composition such that crystallization does not occur. B₂O₃ may be contained in the enamel composition in a range of 1 to 10 wt %. If the content of B₂O₃ exceeds 10 wt %, the addition of other components may be prevented, thereby degrading a cleaning performance. If the content of B₂O₃ is less than 1 wt %, the glass composition may be disrupted or crystallization of the glass composition may occur.

Li₂O, Na₂O, and K₂O each functions to improve the cleaning performance using the enamel composition. At least one of Li₂O, Na₂O, or K₂O may be contained in the enamel composition in a range of 10 to 20 wt %. When the content of the at least one of Li₂O, Na₂O, or K₂O exceeds 20 wt %, a coating performance of the coating layer may be degraded due to a significantly increased coefficient of thermal expansion of the glass. If the content of the at least one of Li₂O, Na₂O, or K₂O is less than 10 wt %, the cleaning function performance may be degraded.

NaF also functions to improve the cleaning performance using the enamel composition. NaF is contained in the enamel composition in a range of 1 to 5 wt %. If the content of NaF exceeds 5 wt %, the addition of other components may be prevented, thereby degrading durability thereof. If the content of NaF is less than 1 wt %, the cleaning performance may be degraded.

In embodiments, SiO₂ and B₂O₃ each functions as a network forming oxide and the alkali metal oxide described above functions as a network modifying oxide, and ZnO functions as an intermediate oxide for balancing the two metal oxides. In embodiments, ZnO may be contained in the enamel composition in the range of 1 to 10 wt %. If the content of ZnO exceeds 10 wt %, vitrification of the enamel composition may be difficult and thermal properties of the enamel composition may be degraded. If the content of ZnO is less than 1 wt %, an ability of the enamel composition to spread during firing may be degraded, resulting in a non-uniform coating, such that surface properties and a coating performance of the coating layer may be degraded.

At least one of TiO₂, MoO₃, Bi₂O₃, CeO₂, MnO₂, or Fe₂O₃ improves the cleaning performance with respect to contaminants, such as oils and sugars. In embodiments, the at least one of TiO₂, MoO₃, Bi₂O₃, CeO₂, MnO₂, or Fe₂O₃ may be contained in the enamel composition in a range of 20 to 50 wt %. If the at least one of TiO₂, MoO₃, Bi₂O₃, CeO₂, MnO₂, or Fe₂O₃ exceeds 50 wt %, the addition of other components may be prevented, thereby degrading durability, such as heat resistance and chemical resistance. If the at least one of TiO₂, MoO₃, Bi₂O₃, CeO₂, MnO₂, or Fe₂O₃ is less than 20 wt %, the cleaning performance with respect to contaminants, such as oils and sugars, may be degraded. According to embodiments, the enamel composition may include 5 to 20 wt % of TiO₂ and 10 to 20 wt % of at least one of MoO₃, Bi₂O₃, or CeO₂ so as to provide an optimal silicate-based composition ratio such that the enamel composition facilitates cleaning and has durability, such as heat resistance and chemical resistance thereof. In some examples, in order to provide an enamel composition that facilitates cleaning and has excellent durability, for example, MoO₃, Bi₂O₃, and CeO₂ may be contained in the enamel composition.

According to embodiments, the enamel composition may be coated on a buffer layer formed on a base steel sheet and may not include relatively expensive Ni and Co components. Accordingly, according to embodiments, the enamel composition may facilitate cleaning and have excellent durability at an economical price.

As mentioned above, other enamel compositions have greater energy consumption because such enamel compositions are heated for about four hours under high temperature conditions, for example, in a temperature range of 450 to 500° C. for pyrolysis to perform cleaning. According to embodiments, the enamel composition has the above-mentioned novel composition ratio such that contaminants containing sugars may be removed by heating for one hour or less at high temperature conditions, for example, a temperature range of 450 to 500° C. for pyrolysis. Accordingly, according to embodiments, the enamel composition may be used to save energy and shorten the cleaning time. According to embodiments, the enamel composition may facilitate the cleaning without soaking in water at room temperature and may facilitate hygiene management of cooking appliances.

### Method for Preparing Enamel Composition

According to embodiments, a method 100 for preparing an enamel composition includes providing materials for the enamel composition (110) including 15 to 50 wt % of SiO₂; 1 to 10 wt % of B₂O₃; 10 to 20 wt % of at least one of Li₂O, Na₂O, or K₂O; 1 to 5 wt % of NaF; 1 to 10 wt % of ZnO; and 20 to 50 wt % of at least one of TiO₂, MoO₃, Bi₂O₃, CeO₂, MnO₂, or Fe₂O₃; melting the materials (120); and quenching the melted materials (130) to prepare the enamel composition.

After the components of the enamel composition are sufficiently mixed, the materials are melted. In some examples, the enamel composition may be melted in a temperature range of 1200 to 1400° C. In some examples, the enamel composition may be melted for 1 to 2 hours. Subsequently, the melted materials may be chilled by a chiller using a quenching roller.

### Cooking Appliance

According to embodiments, an enamel composition may be coated on a surface of a target object. The target object may be a metal plate, a glass plate, or portion or all of a cooking appliance, for example. The enamel composition may be coated on an inner surface of a cavity of the cooking appliance or an inner surface of a door of the cooking appliance.

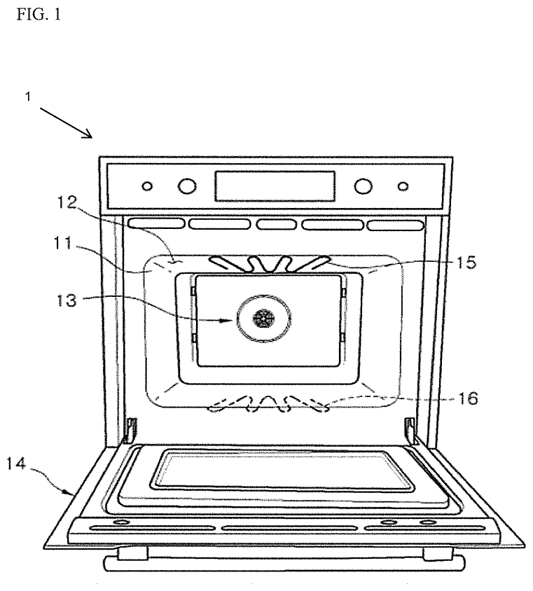

Referring to FIG. 1, according to embodiments, a cooking appliance 1 may include a cavity 11 that defines a cooking chamber, a door 14 that selectively opens and closes the cooking chamber, at least one of heating sources 13, 15, and 16 that provides heat to the cooking chamber, a buffer layer 19 coated on an inner surface 12 of the cavity 11, a buffer layer 20 coated on an inner surface of the door 14, and coating layers 17 and 18 formed using the enamel composition according to embodiments.

The cavity 11 may have a hexahedral shape and have an open front surface. The heating sources 13, 15, and 16 may include a convection assembly 13 that discharges heated air into the cavity 11, an upper heater 15 disposed at an upper portion of the cavity 11, and a lower heater 16 disposed at a lower portion of the cavity 11. The upper heater 15 and the lower heater 16 may be provided inside or outside of the cavity 11. The heating sources 13, 15, and 16 may not necessarily include the convection assembly 13, the upper heater 15, and the lower heater 16. For example, the heating sources 13, 15, and 16 may include at least one of the convection assembly 13, the upper heater 15, or the lower heater 16.

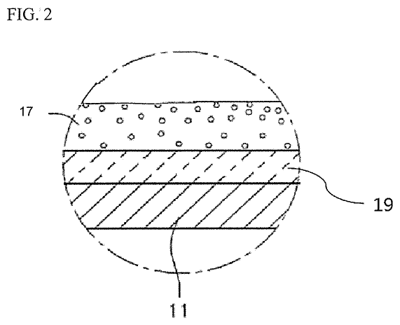

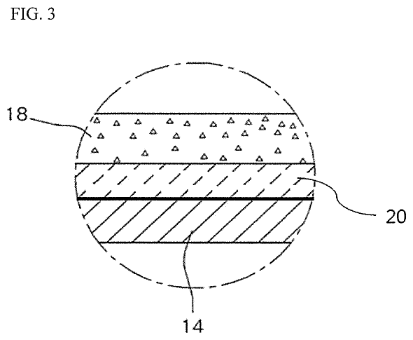

According to embodiments, referring to FIGS. 2 and 3, the enamel composition may be coated on the inner surface of the cavity 11 or the inner surface of the door 14 of the cooking appliance 1 through a dry process or a wet process, for example. The cavity 11 and the door 14 may each be made of a metal plate. Buffer layers 19 and 20 may be formed on surfaces of the cavity 11 and the door 14. According to embodiments, the coating layers 17 and 18 formed using the enamel composition may be coated on the buffer layers 19 and 20.

The buffer layers 19 and 20 may each be formed as a coating layer having similar components to the components of the enamel composition. The buffer layers 19 and 20 may each be made of a material having a same thermal expansion coefficient as a base steel sheet and a material having excellent adhesion with the base steel sheet.

In the dry process, the enamel composition is dispersed in an organic binder and the mixed enamel composition and organic binder are milled in a ball mill to prepare a glass frit. In the wet process, the enamel composition is dispersed in water (H₂O) and pigment, and the mixed enamel composition, water (H₂O), and pigment are milled in a ball mill to prepare a glass frit.

Subsequently, the glass frit prepared through the dry process and the wet process may be applied onto the buffer layer by spray. The applied glass frit may be fired for 100 to 450 seconds in a temperature range of 600 to 900° C. and may be coated on the inner surface of the cavity 11 or the inner surface of the door 14 of the cooking appliance 1.

Hereinafter, embodiments are described with respect to examples.

### Examples

### Method for Preparation of Enamel Composition

An enamel composition having a composition ratio shown in Table 1 below was prepared. Raw materials of components of the enamel composition were sufficiently mixed in a V-mixer for three hours. Sodium carbonate (Na₂CO₃), potassium carbonate (K₂CO₃), and lithium carbonate (Li₂CO₃) were used as raw materials for Na₂O, K₂O, and Li₂O, respectively, and remaining components thereof were the same as those listed in Table 1. The mixed materials were sufficiently melted at 1300° C. for 1 hour and 30 minutes and quenched using a quenching roller to obtain a glass cullet.

The glass cullet obtained through the above process was controlled to have an initial particle size using a mill, for example, a ball mill, and passed through a 325-mesh sheave (ASTM C285-88) after grinding for about five hours using a jet mill. The particle size of the frit, which has not passed through the mesh sheave, was controlled to be 1 to 3 g and powder that has passed through the mesh sheave was used as an enamel frit composition.

TABLE 1

| | | | | | | | | Comparative | | |
|---|---|---|---|---|---|---|---|---|---|---|
| Component | Embodiment | | | | | | | Example | | |
| (wt %) | 1 | 2 | 3 | 4 | 5 | 6 | 7 | 1 | 2 | 3 |
| SiO₂ | 33.29 | 29.77 | 39.49 | 42.53 | 33.98 | 39.49 | 47.52 | 14.22 | 61.22 | 43.25 |
| B₂O₃ | 9.82 | 9.75 | 6.62 | 1.5 | 8.88 | 6.62 | 1.5 | 25.11 | 5.11 | 15.21 |
| Na₂O | 11.76 | 9.7 | 12.03 | 7.76 | 9.74 | 11.95 | 7.76 | 9.7 | 1.23 | 7.76 |
| K₂O | 3.92 | 2.6 | 3.34 | 2.92 | 2.6 | 3.34 | 2.92 | 3.99 | 3.34 | 2.92 |
| Li₂O | 1.32 | 1.31 | 2.12 | 1.02 | 1.29 | 2.12 | 1.02 | 5.21 | 2.12 | 1.02 |
| NaF | 3.29 | 3.27 | 2.8 | 3.29 | 3.27 | 2.8 | 4.11 | 2.11 | 2.8 | 5.22 |
| TiO₂ | 15.3 | 12.79 | 12.97 | 15.29 | 12.21 | 12.97 | 15.29 | 12.79 | 5.22 | 13.9 |
| MnO₂ | 0 | 0.2 | 0 | 0 | 0.2 | 0.3 | 0 | 0 | 0 | 1.21 |
| Fe₂O₃ | 0 | 0.2 | 0 | 0 | 0.2 | 0 | 0.3 | 1.2 | 0 | 0 |
| ZnO | 6.62 | 9.91 | 9.05 | 8.2 | 9.91 | 9.05 | 1 | 8.12 | 8.24 | 1 |
| MoO₃ | 5.18 | 7.82 | 3.58 | 5.59 | 7.86 | 3.36 | 6.68 | 5.01 | 3.58 | 5.59 |
| Bi₂O₃ | 8.21 | 9.86 | 6.71 | 8.51 | 9.86 | 6.71 | 8.51 | 9.72 | 5.85 | 1.23 |
| CeO₂ | 1.29 | 2.82 | 1.29 | 3.39 | 0 | 1.29 | 3.39 | 2.82 | 1.29 | 1.69 |

### Preparation of Specimen for Enamel Composition

A low-carbon steel sheet having an area of 200×200 (mm) and a thickness of 1 (mm) or less was prepared. A buffer layer having components shown in Table 2 below was formed on the sheet. The buffer layer was prepared in the same manner as the enamel composition mentioned above. The method for forming the buffer layer on the sheet is the same as the method for forming the enamel coating layer described below.

Frits prepared according to Embodiments 1 to 7 and Comparative Examples 1 to 3 using the enamel composition were sprayed onto the buffer layer using a corona discharge gun. A voltage of the discharge gun was controlled under the conditions of 40 to 100 kV and an amount of frits sprayed on the low-carbon steel sheet was 300 g/m². The low-carbon steel sprayed with the frit was fired at a temperature range of 830° C. to 870° C. for 300 seconds to 450 seconds to form a coating layer on one surface of the low-carbon steel. In this case, the coating layer was formed with a thickness of about 80 to 250 μm. As a result, the specimens were prepared according to Embodiments 1 to 7 and Comparative Examples 1 to 3.

TABLE 2

| Component | Buffer |
|---|---|
| (wt %) | layer |
| SiO₂ | 48.8 |
| B₂O₃ | 10.1 |
| Na₂O | 15 |
| K₂O | 10.7 |
| Li₂O | 4.2 |
| NaF | 6 |
| TiO₂ | 2.4 |
| Co₃O₄ | 1 |
| NiO | 0.5 |
| Fe₂O₃ | 0.8 |
| MnO₂ | 0.5 |

### Experimental Example

Performance evaluation was performed on specimens according to the Embodiments and Comparative Examples as follows and the results thereof are summarized in Table 1.

### 1. Evaluation of Cleaning Performance for Chicken Oil Contaminants

1 g of chicken oil as a contaminant was applied evenly and thinly onto a surface of specimen, which was prepared by coating an enamel composition on a metal substrate (100×100 mm), using a brush. Subsequently, the specimen to which contaminants were applied was put into a thermostat and the contaminants were fixed in a temperature range of 250 to 290° C. for one hour. After fixing contaminants, the specimen was naturally cooled and a curing degree of each specimen was determined, followed by wiping the cured chicken oils with a force of 3 kgf or less using a frying pan cleaning sponge moistened with room-temperature water. A bar having a diameter of 5 cm and a flat bottom was used to uniformly wipe the contaminants on the surface of the specimen.

### 2. Cleaning Performance for Cherry Pie Contaminants

1 g of cherry pie as a contaminant was applied evenly and thinly using a brush to a specimen surface with which an enamel composition was coated on a metal substrate (100×100 mm). Subsequently, the specimen to which contaminants were applied was put into a thermostat and the contaminants were fixed in a temperature of about 220° C. for 30 minutes. After fixing the contaminants, the specimen was naturally cooled and the contaminants were burned at 400° C. for one hour. Subsequently, cured cherry pie contaminants were wiped off with a force of 3 kgf or less using a frying-pan cleaning sponge moistened with room-temperature water. A bar having a flat bottom and have a diameter of 5 cm was used to uniformly wipe the contaminants on the surface of the specimen.

In this case, a number of cleaning cycles was measured on the specimens. This is referred to as “the number of cleaning cycles”. Cleaning performance evaluation indexes are described in Table 3.

TABLE 3

| Number of | |
|---|---|
| Cleaning Cycles | Level |
| 1 to 5 | LV.5 |
| 6 to 15 | LV.4 |
| 16 to 25 | LV.3 |
| 26 to 50 | LV.2 |
| 51 or more | LV.1 |

### 3. Durability Evaluation

The specimens that have completed the cleaning test according to item 2 above were tested to evaluate durability, such as heat resistance and chemical resistance. The durability of each of the specimens was evaluated by determining a stain phenomenon. The stain phenomenon was evaluated. The surface of each of the specimens was examined and stain phenomenon was evaluated by quantifying a ratio of an area of residues or traces thereof to a total surface area. Evaluation criteria of stain is described in Table 4.

TABLE 4

| Stain Area Ratio | LEVEL |
|---|---|
| 0% | LV.5 |
| less than or equal to 20% | LV.4 |
| less than or equal to 50% | LV.3 |
| less than or equal to 80% | LV.2 |
| equal to or greater than 80% | LV.1 |

TABLE 5

| | | | | | | | | Comparative | | |
|---|---|---|---|---|---|---|---|---|---|---|
| | Embodiment | | | | | | | Example | | |
| Chicken | V.3 | V.5 | V.3 | V.5 | V.5 | V.5 | V.5 | V.2 | V.1 | V.2 |
| oil | | | | | | | | | | |
| cleaning | | | | | | | | | | |
| performance | | | | | | | | | | |
| Cherry pie | V.3 | V.4 | V.4 | V.5 | V.4 | V.4 | V.4 | V.1 | V.1 | V.1 |
| cleaning | | | | | | | | | | |
| performance | | | | | | | | | | |
| Stain level | V.3 | V.4 | V.4 | V.5 | V.5 | V.5 | V.5 | V.1 | V0 | V.1 |

As described in Table 5 above, excellent cleaning performance and durability was determined according to embodiments. Comparative embodiments showed degraded cleaning performance due to poor silicate-based composition and poor durability due to the unstable glass composition compared to comparative examples.

Embodiments disclosed herein provide a novel enamel composition that enables a reduction in a heating time for cleaning. Embodiments disclosed herein also provide a novel enamel composition that may require no soaking in water to remove oil contaminants. Embodiments disclosed herein further provide a novel enamel composition that facilitates cleaning and has excellent durability, such as heat resistance and chemical resistance.

According to embodiments disclosed herein, in order to provide an enamel composition, that facilitates cleaning by reducing a time taken to heat other enamel compositions and facilitates cleaning with respect to oil contaminants at room temperature without soaking in water, the enamel composition may include 15 to 50 percent by weight (wt %) of SiO₂; 1 to 10 wt % of B₂O₃; 10 to 20 wt % of at least one of Li₂O, Na₂O, or K₂O; 1 to 5 wt % of NaF; 1 to 10 wt % of ZnO; and 20 to 50 wt % of at least one of TiO₂, MoO₃, Bi₂O₃, CeO₂, MnO₂, or Fe₂O₃. The enamel composition may include 5 to 20 wt % of TiO₂ and 10 to 20 wt % of at least one of MoO₃, Bi₂O₃, or CeO₂.

Embodiments disclosed herein provide a novel enamel composition that may not be required for determining adhesion with a base steel sheet. According to embodiments disclosed herein, the enamel composition may significantly reduce a time taken to heat other enamel compositions. Accordingly, the heating time may be shortened due to the enamel composition, thereby saving energy used for cleaning.

The enamel composition may also facilitate the cleaning with respect to contaminants, particularly oil contaminants, at room temperature without soaking in water such that users may easily clean it. As such, the enamel composition may improve hygiene of the cooking appliance.

Further, according to embodiments disclosed herein, the enamel composition may have an optimal composition ratio of silicate-based component, thereby facilitating cleaning and having excellent durability such as heat resistance and chemical resistance. Furthermore, the enamel composition may be formed on an intermediate buffer layer disposed on the base steel sheet, thereby requiring no expensive raw material having adhesion with the base steel sheet.

Although embodiments have been described above, embodiments are not limited to the embodiments disclosed herein, and various modifications can be made by those skilled in the art within the scope of the technical idea. Further, even if working effects obtained based on configurations of embodiments are not explicitly described in the description of embodiments, effects predictable based on the corresponding configuration has to be recognized.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for preparing an enamel composition, comprising:
providing materials for the enamel composition, comprising:
15 to 50 percent by weight (wt %) of silicon dioxide (SiO2);
1 to 10 wt % of boron oxide (B2O3);
10 to 20 wt % of at least one of lithium oxide (Li2O), sodium oxide (Na2O), or potassium oxide (K2O);
1 to 5 wt % of sodium fluoride (NaF);
1 to 10 wt % of zinc oxide (ZnO);
10 to 30 wt % of at least one of titanium dioxide (TiO2), manganese dioxide (MnO2), or Iron oxide (Fe2O3) and 10 to 20 wt % of molybdenum oxide (MoO3), bismuth oxide (Bi2O3), and cerium dioxide (CeO2) in total, wherein the enamel composition is a silicate-based glass composition;
melting the materials; and
quenching the melted materials to form the enamel composition.

2. A cooking appliance, comprising:
a cavity configured to define a cooking chamber;
a door configured to selectively open and close the cooking chamber;
at least one heating source configured to supply heat to the cooking chamber;
a buffer layer coated on an inner surface of the cavity or an inner surface of the door; and
a coating layer coated on the buffer layer and formed using the method of claim 1.

3. The method in claim 1, wherein the melting of the materials includes melting the materials at about 1,200 to 1,400° C. for about one to two hours.

4. The method in claim 3, wherein the melting of the materials includes melting the materials at about 1,300° C. for about 1.5 hours.

5. The method of claim 1, further comprising:
mixing the materials for about 3 hours before melting the materials.

6. The method of claim 1, wherein the quenching of the melted material includes quenching the melted materials using a quenching roller.

7. The method of claim 1, further comprising:
applying the enamel composition to at least one of an inner surface of a cavity of a cooking appliance or an inner surface a door of the cooking appliance.

8. The method of claim 7 wherein the applying of the enamel composition includes applying the enamel composition by a dry process that includes dispersing the quenched materials for the enamel composition in an organic binder, milling the quenched materials for the enamel composition and the organic binder to prepare a frit, and applying the frit to the at least one of the inner surface of the cavity of the cooking appliance or the inner surface the door of the cooking appliance.

9. The method of claim 7, wherein the applying of the enamel composition includes applying the enamel composition by a wet process that includes dispersing the quenched materials for the enamel composition in water and a pigment, milling the materials for the enamel composition, water, and the pigment to prepare a frit, and applying the frit to the at least one of the inner surface of the cavity of the cooking appliance or the inner surface the door of the cooking appliance.

10. The method of claim 7, wherein the applying of the enamel composition includes:
spraying a frit that includes the quenched materials for the enamel composition to the at least one of the inner surface of the cavity of the cooking appliance or the inner surface the door of the cooking appliance; and
firing the sprayed frit.

11. The method of claim 10, wherein the spraying of the frit includes spraying about 300 g/m2 of the frit onto a steel sheet substrate.

12. The method of 10, wherein the spraying of the frit includes directly applying a single layer of the frit onto a steel sheet substrate without using an interposing buffer layer.

13. The method of claim 10, wherein the frit is applied to form a coating layer having a thickness of about 80 to 250 μm, and the frit is fired at about 600 to 900° C. for about 100 to 450 seconds.
